(19) United States
(12) Patent Application Publication
(10) Pub. No.: US 2004/0202292 A1
(43) Pub. Date: Oct. 14, 2004

(54) Mobile station tracking in a wireless telecommunication system

(76) Inventor: Jennifer Cook, Gurnee, IL (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/272,649

(22) Filed: Oct. 17, 2002

(51) Int. Cl. H04Q 7/20; G01S 1/00

(52) U.S. Cl. 379/67.1; 342/357.07; 342/357.09; 342/357.12; 455/456.1

(57) ABSTRACT

Providing mobile station tracking in a wireless telecommunication system comprises tracking a geographic location of a mobile station, the mobile station attached to a first subject, and updating periodically a tracking server with geographic data, the geographic data comprising the geographic location of the mobile station. In addition, providing mobile station tracking includes receiving a request from a second subject for the geographic data, and providing the geographic data to the second subject, the mobile station configured to communicate wirelessly with only one communication unit predetermined by the second subject.

### DESCRIPTION OF THE INVENTION

1. Field of the Invention

The invention generally relates to systems and methods for providing mobile station tracking in a wireless telecommunication system, and more particularly, to systems and methods for providing the geographic location of a mobile station in a wireless telecommunication system.

2. Background of the Invention

The use of telephone products and systems in the day-to-day lives of most people is continually growing. With the advent and steady growth of wireless telecommunications, wireless telecommunication systems will increasingly be utilized for not only voice data, but also for sending and receiving packetized data for use on the Internet, for example. In an effort to lower operating costs and increase value for its subscribers, wireless telecommunication providers wish to provide mobile station tracking in the wireless telecommunication system. Wireless telecommunication system providers may realize a competitive advantage by creating new value added service that may attract new subscribers to the wireless telecommunication system or that may tend to retain current subscribers.

Therefore, the need to efficiently provide mobile station tracking in a wireless telecommunication system has become a common need for many wireless telecommunication providers. More specifically, providing the geographic location of a mobile station in a wireless telecommunication system has become a critical service for many wireless telecommunication providers. This is because in an increasingly competitive environment, meeting and exceeding the expectations of subscribers or others who receive services is essential for a wireless telecommunication provider.

One solution to the mobile station tracking problem, for example, is for a subscriber to simply call a subject who wishes to track the location of the subscriber and verbally let the subject know the subscriber's location. Great inefficiencies are created by this procedure because, for example, the subscriber or the subject may be occupied with other activates and calling in the location or receiving the location would create a great inconvenience for either party. In addition, the subscriber may be unconscious or may not be cognizant of their present geographic location. Accordingly, efficiently providing mobile station tracking in a wireless telecommunication system remains an elusive goal.

Thus, there remains a need for efficiently providing mobile station tracking in wireless a telecommunication system. In addition, there remains a need for providing the geographic location of mobile stations in a wireless telecommunication system.

### SUMMARY OF THE INVENTION

Consistent with the present invention, methods and systems for providing mobile station tracking in a wireless telecommunication system are provided that avoid problems associated with prior attempts for tracking mobile stations in a wireless telecommunication system as discussed above.

In one aspect, a method for providing mobile station tracking in a wireless telecommunication system comprises tracking a geographic location of a mobile station, the mobile station attached to a first subject, updating periodically a tracking server with geographic data, the geographic data comprising the geographic location of the mobile station, receiving a request from a second subject for the geographic data, and providing the geographic data to the second subject, the mobile station configured to communicate wirelessly with only one communication unit predetermined by the second subject.

In another aspect, a system for providing mobile station tracking in a wireless telecommunication system comprises a component for tracking a geographic location of a mobile station, the mobile station attached to a first subject, a component for updating periodically a tracking server with geographic data, the geographic data comprising the geographic location of the mobile station, a component for receiving a request from a second subject for the geographic data, and a component for providing the geographic data to the second subject, the mobile station configured to communicate wirelessly with only one communication unit predetermined by the second subject.

In yet another aspect, a computer-readable medium on which is stored a set of instructions for providing mobile station tracking in a wireless telecommunication system, which when executed perform stages comprising tracking a geographic location of a mobile station, the mobile station attached to a first subject, updating periodically a tracking server with geographic data, the geographic data comprising the geographic location of the mobile station, receiving a request from a second subject for the geographic data, and providing the geographic data to the second subject, the mobile station configured to communicate wirelessly with only one communication unit predetermined by the second subject.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for providing mobile station tracking in a wireless telecommunication system consistent with an embodiment of the present invention;

FIG. 2 is a flow chart of an exemplary method for providing mobile station tracking in a wireless telecommunication system consistent with an embodiment of the present invention; and

FIG. 3 is an illustration of an exemplary display consistent with an embodiment of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention, a system for providing mobile station tracking in a wireless telecommunication system may comprise a component for tracking a geographic location of a mobile station, the mobile station attached to a first subject, a component for updating periodically a tracking server with geographic data, the geographic data comprising the geographic location of the mobile station, a component for receiving a request from a second subject for the geographic data, and a component for providing the geographic data to the second subject, the mobile station configured to communicate wirelessly with only one communication unit predetermined by the second subject.

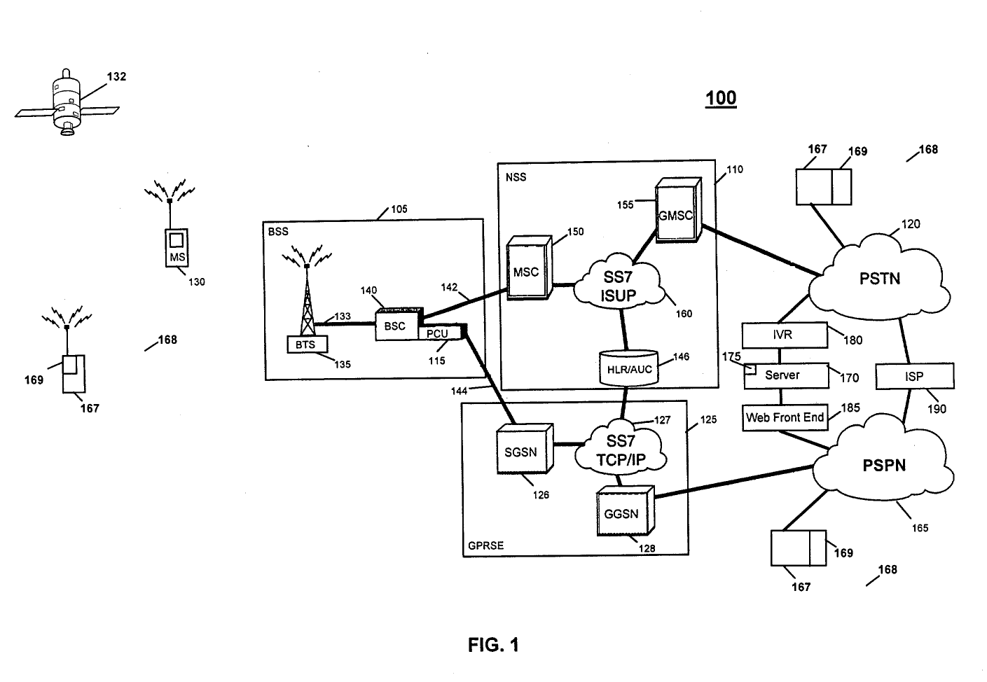

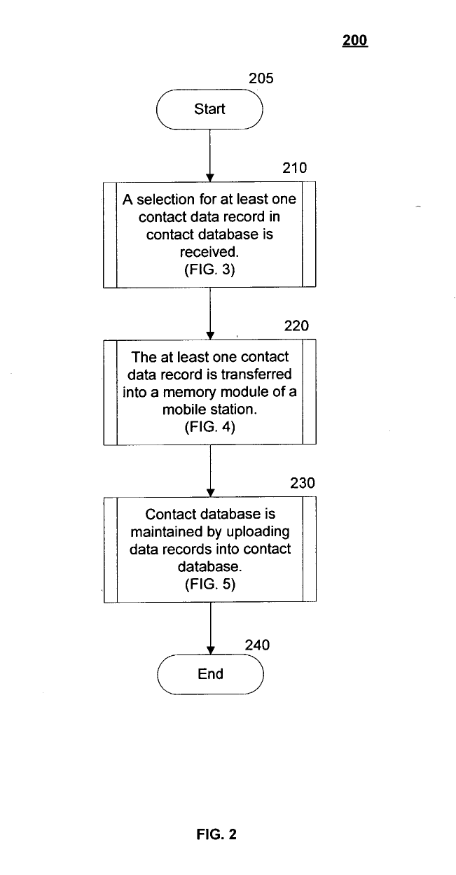

As herein embodied and illustrated in FIG. 1, a system for providing mobile station tracking 100 may comprise a base station subsystem (BSS) 105, a network and switching subsystem (NSS) 110, a mobile station (MS) 130, a publicly switched telephone network (PSTN) 120, a publicly switched packet network (PSPN) 165, a user system 167, a tracking server 170, a tracking database 175, an interactive voice response system (IVR) 180, a web front end 185, and an Internet service provider (ISP) 190. Tracking data server 170, tracking database 175, interactive voice response system (IVR) 180, and web front end 185 may be owned, operated, and maintained by an operator of system 100 or by a third party. The elements of system 100 will be described in detail below.

Consistent with an exemplary embodiment of the invention, the component for tracking, the component for updating, the component for receiving, and the component for providing may comprise tracking server 170. Those of ordinary skill in the art, however, will appreciate that other elements of system 100 may, by themselves or in conjunction with other elements, comprise the component for tracking, the component for updating, the component for receiving, or the component for providing.

System 100 may utilize global system for mobile communications (GSM), technology enhanced with general packet radio service (GPRS) in embodiments of the present invention. GSM, developed in the 1980s and predominantly used in Europe, operate in the 900 MHz and 1.8 GHz bands in Europe and the 1.9 GHz PCS band in the U.S. GSM phones may use a subscriber identity module (SIM) smart card that contains user account information. GSM phones are automatically programmed by plugging in the SIM card, allowing GSM phones to be used interchangeably in situations such as renting or borrowing. In addition, GSM may include short messaging service (SMS) that enables text messages up to 160 characters in length to be exchanged. GSM supports data transfer rates of 9.6 Kbps to packet networks.

GPRS is an enhancement for GSM that supports packetized data. GPRS enables a continuous flow of Internet Protocol data packets over the telecommunication system for applications such as Web browsing and file transfer. GPRS differs from SMS because SMS is limited to messages of 160 bytes in length, GPRS has no such limit. Additionally, those skilled in the art will appreciate that EDGE is an enhancement to the GSM and TDMA wireless telecommunication systems that increases data throughput.

Those of ordinary skill in the art will appreciate that other wireless telecommunication technology standards, in addition to GSM and GPRS, may be employed, for example, FDMA, TDMA, CDMA, CDMA2000, UTMS, and EDGE, without departing from the spirit of the invention.

Wireless telecommunication may include radio transmission via the airwaves, however, those of ordinary skill in the art will appreciate that various other telecommunication techniques can be used to provide wireless transmission including infrared line of sight, cellular, microwave, satellite, blue-tooth packet radio, and spread spectrum radio. Wireless data may include, but is not limited to, paging, text messaging, e-mail, Internet access, instant messaging, and other specialized data applications specifically excluding or including voice transmission.

As shown in FIG. 1, BSS 105 may comprise, for example, a base station controller (BSC) 140, a base transceiver station (BTS) 135, and a packet control unit (PCU) 115. BSS 105 connects to MS 130 through a radio interface and connects to NSS 110 through an interface 142. BSC 140 controls BTS 135 and may control a plurality of other base transceiver stations in addition to BTS 135. BTS 135 may comprise radio transmission and reception equipment located at an antenna site. Associated with BSS 105, a transcoder/rate adaptation unit (TRAU) (not shown) may perform speech encoding and speech decoding and rate adaptation for transmitting data. As a subpart of BTS 135, the TRAU may be located away from BTS 135, for example, at a mobile switching center located in NSS 110. When the TRAU is located in this way, the low transmission rate of speech code channels allows more compressed transmission between BTS 135 and the TRAU.

PCU 130 connects BSS 105 to GPRSE 125, which allows, for example, the Internet to link with MS 130. PCU 115 adds level 2 functions of GPRS such as data aware radio link control (RLC) and the MAC protocol layer as well as performing radio resource configuration and channel assignment.

GSM systems may use open system interconnection (OSI). There are several common interfaces defined by OSI such as a common radio interface (referred to as air interface) used between MS 130 and BTS 135, and an A-bis interface 133 used between BTS 135 and BSC 140. With common interfaces such as those defined by OSI, a telecommunication system operator can utilize and interchange equipment of various manufactures when implementing communication systems. The difference between interface and protocol is that an interface represents the point of contact between two adjacent entities (equipment or systems) and a protocol provides information flows through the interface. For example, the GSM radio interface is the transit point for information flow pertaining to several protocols. Interface 142 between NSS 110 and BSS 105 may comprise T-1 lines using X.25 or TCP/IP protocol, for example.

MS 130 may comprise a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information. In an exemplary embodiment of the present invention, MS 130 may be configured to mount to the arm or configured to hang from the neck of a first subject 131 and may be further configured to play games or provide the current time and date. In addition, MS 130 may be placed in a holder athletically pleasing to first subject 131. For example, if first subject 131 is a child, the holder may display the child's favorite story book or cartoon character. Furthermore, MS 130 may be configured to communicate with only one other device or a small limited number of other devices or device addresses. For example, upon pressing a button on MS 130, a preprogrammed telephone number or direct connect radio address may be called. Moreover, this preprogrammed telephone number or address may be programmed when MS is first initialized.

MS 130 may utilize cellular telephone protocols such as wireless application protocol (WAP). Such mobile systems may also be configured to permit the user to purchase products through a browser on a display of the mobile device. The invention, as disclosed in this embodiment, in its broadest sense is not limited to a particular form of mobile system or communication protocol. And those of ordinary skill in the art will recognize that other systems and components may be utilized within the scope and spirit of the invention.

Moreover, MS 130 may be a stand-alone piece of equipment for certain services or support the connection of external terminals, such as the interface for a personal computer or facsimile machine. MS 130 may include mobile equipment (ME) (not shown) or a subscriber identity module (SIM). The ME does not need to be personally assigned to one subscriber. GSM phones, for example, may use a SIM card that contains subscriber account information, as GSM phones may be automatically programmed by plugging in the SIM card. This allows GSM phones to be used interchangeably in situations such as renting or borrowing. When a subscriber's SIM is inserted into the ME of MS 130, all calls for the subscriber are delivered to MS 130. Thus, the ME is not associated with a particular number, but rather, is linked to the subscriber's SIM.

Furthermore, MS 130 may be configured to utilize the Global Positioning System (GPS). GPS is a system of 24 satellites for identifying earth locations created by the U.S. Department of Defense. By triangulation of signals from three of the satellites in the GPS, which may include satellite 132, a receiving unit, MS 130 for example, can pinpoint its current location anywhere on earth to within a small margin of error. By using GPS, MS 130 may periodically calculate its location and send its location, in the form of geographic data, periodically to server 170, either through NSS 110 and PSTN 120 or through GPRSE 125 and PSPN 165. The interfaces between PSTN 120 and tracking sever 170, and PSPS 165 and tracking server 170 will be described in greater detail below. Those of ordinary skill in the art will appreciate that there are many other way to send geographic data from MS 130 to tracking server 170, including, for example, a direct connection from BSS 105, NSS 110, or GPRSE 125 to tracking server 170. In addition, those of ordinary skill in the art will appreciate that there are way other than using GPS to obtain geographic data.

In addition, GSM systems may include short messaging service (SMS) that enables text messages up to 160 characters in length to be exchanged. SMS is a text message service that enables short messages of generally no more than 140-160 characters in length to be sent and transmitted from mobile stations. SMS was first introduced in the GSM system and later supported by other digital-based mobile communication systems. Unlike paging, short messages are stored and forwarded in SMS centers. SMS messages travel to mobile stations over the wireless telecommunication system's control channels, which are separate and apart from voice channels.

Still referring to FIG. 1, NSS 110 may comprise a mobile switching center (MSC) 150, a first network 160, a home location register/authentication center (HLR/AUC) 146, and a gateway mobile switching center (GMSC) 155. NSS 110 manages the communication between subscribers, for example, an operator using MS 130, and other telecommunication users, for example, those using publicly switched telephone network (PSTN) 120. PSTN 120 may comprise, for example, the worldwide voice telephone network.

MSC 150 coordinates call set-up to and from subscribers using MS 130. MSC 150 may control several base station controllers such as, and similar to BSC 140. GMSC 155 is used to interface with external networks for communication with users outside of the wireless system, such users on PSTN 120.

HLR/AUC 146 may comprise a stand-alone computer without switching capabilities, a database which contains subscriber information, and information related to the subscriber's current location, but not the actual location of the subscriber. The AUC portion of HLR/AUC 146 manages the security data for subscriber authentication. Another sub-division of HLR/AUC 146 may include an equipment identity register (EIR) (not shown) which may store data relating to mobile equipment (ME).

NSS 110 may also include a visitor location register (VLR) (not shown). The VLR links to one or more mobile switching center located on other systems, temporarily storing subscription data of subscribers currently served by MSC 150. The VLR holds more detailed data than HLR/AUC 146. For example, the VLR may hold more current subscriber location information than the location information at HLR/AUC 230.

GMSC 155 is utilized to interface with PSTN 120. In order to set up a requested call, the call is initially routed to GMSC 155, that finds the correct home location register by knowing the director number of the subscriber. GMSC 155 has an interface with an external network, such as PSTN 120, for gatewaying communications.

The elements of NSS 110 are connected using first network 160. First network 160 may comprise an intelligent network utilizing signal system 7 (SS7) in an ISDN user part (ISUP) protocol. SS7 is a global standard for telecommunications defined by the Telecommunication Standardization Sector of the International Telecommunication Union. The SS7 standard defines the procedures and protocol by which network elements in a public switched telephone network exchange information over a digital signaling network to effect wireless and wireline call setup, routing, and control. ISUP defines the protocol and procedures used to set-up, manage, and release trunk circuits that carry voice and data calls over a public switched telephone network. ISUP is used for both ISDN and non-ISDN calls. Calls that originate and terminate at the same switch do not use ISUP signaling.

As shown in FIG. 1, GPRSE 125 may comprise a serving GPRS service node (SGSN) 126, a second network 127, and a gateway GPRS service node (GGSN) 128. In order to implement GPRS, two new node types may be added to a conventional GSM network, GGSN 128 and SGSN 126. Also, the interfaces to the conventional GSM system may be augmented and an extra unit, such as PCU 115 that may be located in BSS 105 as described above, may be added.

SGSN 126 connects GPRSE 125 to BSS 105 through interface 144, which may comprise T-1 lines using X.25 or TCP/IP protocol, for example. SGSN 126 receives the traffic from mobile subscribers associated with BSS 105 and forwards the traffic to GGSN 128. SGSN 126 uses its links with HLR/AUC 146 to authenticate and bill subscribers, and may provide additional services such as data compression, session management and encryption.

GGSN 128 acts as a gateway to PSPN 165, which is most often a publicly switched packet network such as the Internet. Data is sent across the GPRS network to GGSN 128, un-encapsulated, and then forwarded to the next node. To the outside world GGSN 128 may appear as just another router on the Internet. Common features of GGSN 128 may include firewall/packet-filtering technologies and a dynamic host configuration protocol (DHCP) server to configure IP options of MS 130 as it logs onto the network. DHCP automatically assigns IP addresses to client stations logging onto a TCP/IP network. It eliminates having to manually assign permanent IP addresses. DHCP software typically runs in servers and is also found in network devices such as ISDN routers and modem routers that allow multiple users access to the Internet.

SGSN 126 and GGSN 128 are connected through second network 127. Second network 127 may employ SS7 as described above and use transmission control protocol/Internet protocol (TCP/IP).

User device 167 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information as know by those of ordinary skill in the art. User device 167 may comprise a communication unit 169 capable of providing voice or data communications between communication unit 169 and MS 130. For example, communication unit 169 may include a radio, a cellular telephone, a wire line telephone, a hand-held computing device, microprocessor-based or programmable consumer electronic device, a personal digital assistant (PDA), a facsimile machine, a pager, or a portable computer. Those of ordinary skill in the art will appreciate that may other types of devices may comprise communication unit 169.

For example, a second subject 168, operating via communication unit 169 of user device 167 through PSPN 165, may access or be accessed by first subject 131 using MS 130 through GPRSE. Likewise, second subject 168, operating via communication unit 169 of user device 167 through PSTN 120, may access or be accessed by first subject 131 using MS 130 through NSS 110. Through either NSS 110 and PSTN 120 or GPRSE 125 and PSPN 165, MS 130 may ultimately access or be accessed by user device 167. In addition, communication unit 169 may comprise a wireless unit and communicate with MS 130 using any wireless technology including, for example, cellular or direct connect radio. Moreover, those of ordinary skill in the art will appreciate that there are many other way in which MS 130 and communication unit 169 may ultimately communicate and exchange voice, data, and other information. In addition, those skill in the art will appreciate that communication unit 169 and user device 167 and be one device or separate devices.

Tracking server 170 may comprise a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device for receiving and/or transmitting information as know by those of ordinary skill in the art. Tracking database 175 may be located on storage media in tracking server 170 or other storage media in systems, servers, or components accessible by tracking server 170. Tracking database 175 may at least comprise geographic data that may include geographic coordinates of MS 130 at a given time. Those of ordinary skill in the art will appreciate, however, that the geographic data may include elements other than coordinates of MS 130 at a given time.

Connecting tracking server 170 to PSTN 120 is IVR 180. An IVR is an automated telephone answering system that responds with a voice menu and allows the user to make choices and enter information via the keypad. IVR systems are widely used in call centers as well as a replacement for human operators and may also integrate database access and fax response. Using a dual-tone multifrequency (DTMF) signal such as those generated by a telephone keypad, data may be entered into IVR 180 from a telephone, for example, communication unit 169, by a DTMF signal passing from communication unit 169 through BSS 105, NSS 110, PSTN 120, and to IVR 180. From IVR 180, the data may then be pushed onto a LAN, for example, to tracking server 170 and stored in tracking database 175 on tracking server 170. As an enhancement to IVR 180, a voice portal (not shown) may be employed. With a voice portal, rather than pressing keys of the DTMF key pad, a user, for example, second subject 168, may speak a word or phrase into a microphone on communication unit 169 in order to make a menu selection.

Connecting tracking server 170 to PSPN 165 is web front end 185. One function of web front end 185 is to provide an Internet interface for tracking server 170. As is known to those skilled in the art, a “web front end” is a computer system that receives hypertext transfer protocol (http) requests from a web browser computer program directed to a specific URL, and provides responses to the requesting computer system that, when processed by the web browser computer program, displays a page of the Internet web site associated with the URL. For example, an exemplary URL employed for the present invention may comprise “http://www.trackingdata.com”. Directing an Internet-connected computer system with an operative Internet web browser program at this URL causes display of the home page associated with this web site on the computer's display. Such operations are well known to those skilled in the art and will not be discussed further herein.

Rather than using GPRSE 125, MS 130 or communication unit 169 may connect to tracking server 170 through NSS 110, PSTN 120, Internet service provider (ISP) 190, and then to PSPN 165 and web front end 185. An Internet service provider is an organization that provides access to the Internet, for example, from a publicly switched telephone network. Small Internet service providers provide service via modem and ISDN while the larger ones also offer private line hookups such as T1 lines or fractional T1 lines.

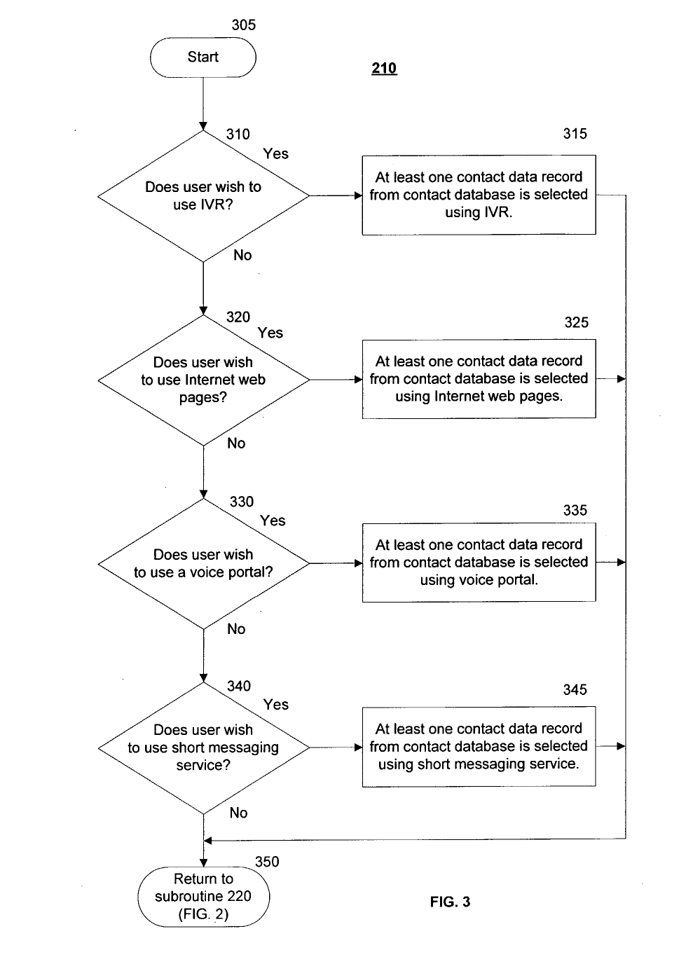

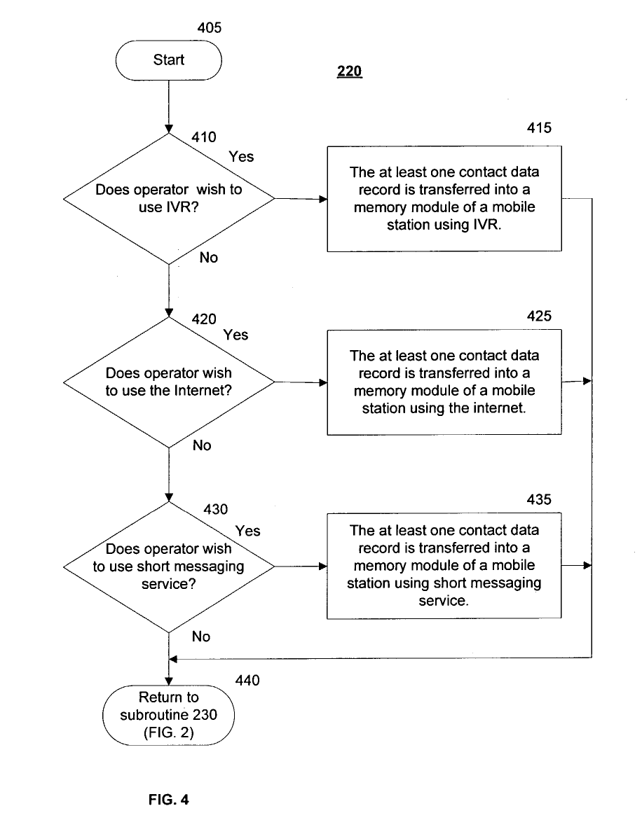

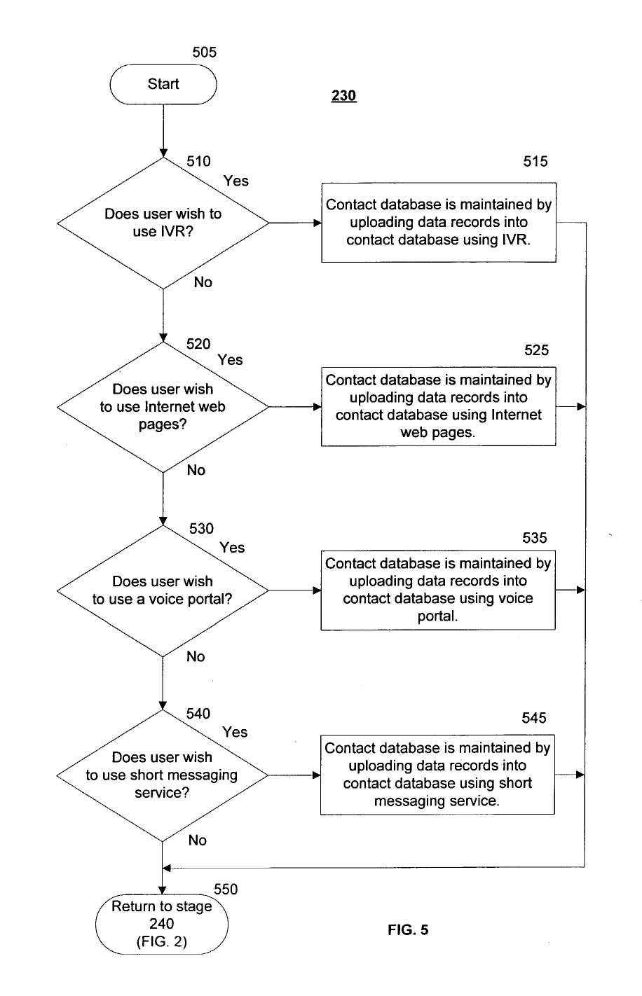

FIG. 2 is a flow chart setting forth the general stages involved in an exemplary method for providing mobile station tracking in a wireless telecommunication system consistent with an embodiment of the present invention. Exemplary method 200 begins at starting block 205 and advances to stage 210 where the geographic location of MS 130 is tracked. For example, MS 130 may be configured to calculate its position using GPS. Specifically, mobile station 130 may be attached to first subject 131, for example, by mounting MS 130 on the clothing, or around the neck or arm of first subject 131. As first subject 131 moves, for example, a child moving through a neighborhood, MS 130 may periodically recalculate the coordinates corresponding to the position of MS 130 using GPS and thus the position of first subject 131. Consistent with an embodiments of the present inventions, first subject 131 may comprise at lest one of a child, a teenager, a parent, an employee, a student, a pet, or livestock. Those of ordinary skill in the art will appreciate that first subject 131 may comprise many different entities.

After the geographic location of MS 130 is tracked in stage 210, exemplary method 200 advances to stage 215 where tracking server 170 is updated periodically with the geographic data. For example, consistent with an embodiment of the invention, the geographic data may comprise the geographic location of the mobile station. Specifically, the geographic location may comprise a coordinate pair indicating a location of MS 130 at a particular time. The coordinate pair and corresponding time may be stored in tracking database 175. Those of ordinary skill in the art will appreciate that the geographic data may comprise many different types of data in various formats.

The geographic data may be transmitted to tracking server 170 through, for example, BSS 105, NSS 110, and PSTN 120; BSS 105, GPRSE 125, and PSTN 165; or through a direct connection (not shown) between tracking server 170 and BSS 105, NSS 110, or GPRSE 125. Those skilled in the art will appreciate that there are many different ways to transfer the geographic data from MS 130 to tracking server 170.

Once tracking server is updated periodically with the geographic data in stage 215, exemplary method 200 advances to stage 220 where a request is received from second subject 168 for the geographic data. For example, second subject 168 may, after obtaining secure access, manifest a desire to obtain the geographic data from secure server 170 through either IVR 180 or web front end 175. Those of ordinary skill in the art will appreciate that there are many ways to receive a request from second subject 168 including using, for example, e-mail, a facsimile machine, Internet web pages, and an interactive voice response system (IVR).

After a request is received from second subject 168 for the geographic data in stage 220, exemplary method 200 continues to stage 225 where the geographic data is provided to second subject 168. For example, as shown on FIG. 3, through web front end 185, tracking server 170 may present a tracking web page 305 to second subject 168. Tracking web page 305 may comprise a map with a tracking indicator 310 illustrating where MS 130 was at a particular time 315. Similar to the request received from second subject 168 for the geographic data, geographic data may be provided to second subject 168 through either IVR 180 or web front end 175. Those of ordinary skill in the art will appreciate that there are many ways to provide geographic data to second subject 168 including using, for example, e-mail, a facsimile machine, Internet web pages, and an interactive voice response system (IVR).

Moreover, MS 130 may be configured to communicate wirelessly with only one communication unit 169 predetermined by second subject 168. For example, if first subject 131 is a child and second subject 168 is the child's parent, the parent may have MS 130 preprogrammed to communicate only with the parent's home wire line telephone number or the parent's cellular telephone number. In addition, MS 130 and communication unit 169 may be configured to communicate wirelessly over a direct connect radio system or a cellular telephone system.

Once the geographic data is provided to second subject in stage 225, exemplary method 200 advances to stage 230 where updated geographic data is provided to second subject, for example as tracking server 170 is periodically updated with the geographic data. If Internet web pages are used, for example, refreshed data screens may be presented to second subject 168 through user device 167 showing a new location as MS 130 moves in time. From stage 230 where updated geographic data is provided to second subject 168, exemplary method 200 ends at stage 235.

It will be appreciated that a system in accordance with an embodiment of the invention can be constructed in whole or in part from special purpose hardware or a general-purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing mobile station tracking in a wireless telecommunication system, comprising:
tracking a geographic location of a mobile station, the mobile station attached to a first subject;
updating periodically a tracking server with geographic data, the geographic data comprising the geographic location of the mobile station;
receiving a request from a second subject for the geographic data; and
providing the geographic data to the second subject, the mobile station configured to communicate wirelessly with only one communication unit predetermined by the second subject.

2. The method of claim 1, further comprising providing updated geographic data to the second subject when the tracking server is periodically updated with the geographic data.

3. The method of claim 1, wherein the mobile station and the communication unit are configured to communicate wirelessly over at least one of a direct connect radio system and a cellular telephone system.

4. The method of claim 1, wherein at least one of providing the geographic data to the second subject and receiving a request from the second subject further comprises utilizing at least one of e-mail, facsimile, Internet, and an interactive voice response system (IVR).

5. The method of claim 1, wherein tracking the geographic location of the mobile station further comprising utilizing the Global Positioning System (GPS).

6. The method of claim 1, wherein the mobile station is further configured to communicate with the communication unit predetermined by the second subject when the mobile station is first activated.

7. The method of claim 1, wherein the first subject comprises at lest one of a child, a teenager, a parent, an employee, a student, a pet, a livestock.

8. The method of claim 1, wherein the mobile station is attached to the first subject by at least one of mounting to the subject's wrist, mounting to the subject via a necklace, and clipping to the subject's clothing.

9. The method of claim 1, further comprising placing the mobile station in a holder, the appearance of the holder configured to be aesthetically pleasing to the first subject.

10. The method of claim 1, wherein the mobile station is configured to at least one of play games with the first subject and display the current time.

11. A system for providing mobile station tracking in a wireless telecommunication system, comprising:
a component for tracking a geographic location of a mobile station, the mobile station attached to a first subject;
a component for updating periodically a tracking server with geographic data, the geographic data comprising the geographic location of the mobile station;
a component for receiving a request from a second subject for the geographic data; and
a component for providing the geographic data to the second subject, the mobile station configured to communicate wirelessly with only one communication unit predetermined by the second subject.

12. The system of claim 11, wherein the component for providing the geographic data is further configured to provide updated geographic data to the second subject when the tracking server is periodically updated with the geographic data.

13. The system of claim 11, wherein the mobile station and the communication unit are configured to communicate wirelessly over at least one of a direct connect radio system and a cellular telephone system.

14. The system of claim 11, wherein at least one of the component for providing the geographic data to the second subject and the component for receiving a request from the second subject is further configured to utilize at least one of e-mail, facsimile, Internet, and an interactive voice response system (IVR).

15. The system of claim 11, wherein the component for tracking the geographic location of the mobile station is further configured for utilizing the Global Positioning System (GPS).

16. The system of claim 11, wherein the mobile station is further configured to communicate with the communication unit predetermined by the second subject when the mobile station is first activated.

17. The system of claim 11, wherein the first subject comprises at lest one of a child, a teenager, a parent, an employee, a student, a pet, a livestock.

18. The system of claim 11, wherein the mobile station is attached to the first subject by at least one of mounting to the subject's wrist, mounting to the subject via a necklace, and clipping to the subject's clothing.

19. The system of claim 11, wherein the mobile station is placed in a holder, the appearance of the holder configured to be aesthetically pleasing to the first subject.

20. The system of claim 11, wherein the mobile station is configured to at least one of play games with the first subject and display the current time.

21. A computer-readable medium on which is stored a set of instructions for providing mobile station tracking in a wireless telecommunication system, which when executed perform stages comprising:
tracking a geographic location of a mobile station, the mobile station attached to a first subject;
updating periodically a tracking server with geographic data, the geographic data comprising the geographic location of the mobile station;
receiving a request from a second subject for the geographic data; and
providing the geographic data to the second subject, the mobile station configured to communicate wirelessly with only one communication unit predetermined by the second subject.

22. The computer-readable medium of claim 21, further comprising providing updated geographic data to the second subject when the tracking server is periodically updated with the geographic data.

23. The computer-readable medium of claim 21, wherein the mobile station and the communication unit are configured to communicate wirelessly over at least one of a direct connect radio system and a cellular telephone system.

24. The computer-readable medium of claim 21, wherein at least one of providing the geographic data to the second subject and receiving a request from the second subject further comprises utilizing at least one of e-mail, facsimile, Internet, and an interactive voice response system (IVR).

25. The computer-readable medium of claim 21, wherein tracking the geographic location of the mobile station further comprising utilizing the Global Positioning System (GPS).

26. The computer-readable medium of claim 21, wherein the mobile station is further configured to communicate with the communication unit predetermined by the second subject when the mobile station is first activated.

27. The computer-readable medium of claim 21, wherein the first subject comprises at lest one of a child, a teenager, a parent, an employee, a student, a pet, a livestock.

28. The computer-readable medium of claim 21, wherein the mobile station is attached to the first subject by at least one of mounting to the subject's wrist, mounting to the subject via a necklace, and clipping to the subject's clothing.

29. The computer-readable medium of claim 21, further comprising placing the mobile station in a holder, the appearance of the holder configured to be aesthetically pleasing to the first subject.

30. The computer-readable medium of claim 21, wherein the mobile station is configured to at least one of play games with the first subject and display the current time.
